(19) United States
(12) Patent Application Publication
(10) Pub. No.: US 2015/0371001 A1
(43) Pub. Date: Dec. 24, 2015

(54) SYSTEMS AND METHODS FOR E-PRESCRIPTION TRANSACTION PRE-DESTINATION EVALUATION, EDITING, REJECTION, AND MESSAGING

(71) Applicant: MCKESSON CORPORATION, San Francisco, CA (US)

(72) Inventors: Roger G. Pinsonneault, Alpharetta, GA (US); ELIZABETH S. KAYE, Suwanee, GA (US)

(21) Appl. No.: 14/674,944

(22) Filed: Mar. 31, 2015

Related U.S. Application Data
(60) Provisional application No. 62/016,088, filed on Jun. 23, 2014.

(51) Int. Cl. G06F 19/00

(52) U.S. Cl. CPC G06F 19/3456

(57) ABSTRACT

A service provider computer can receive an e-prescription transaction from a prescriber computer and evaluate the data therein to determine if errors exist or if required data elements are missing. A rejection of the e-prescription transaction can be generated or the transaction can be modified if errors exist, if data elements are missing, and/or if additional tests or additional information in the transaction is needed. If modified, the transaction can be sent to the pharmacy computer. The rejection response can include a reject code, basis for rejection, and override code, and can be transmitted back to the prescriber computer. Similarly, the service provider computer can receive an e-prescription transaction from the pharmacy computer, evaluate the data therein, and identify any errors or missing data. The e-prescription transaction can be modified to correct errors and omissions and transmitted to the prescriber computer or rejected and transmitted back to the pharmacy computer.

### CROSS-REFERENCE TO RELATED APPLICATIONS

This application claims priority under 35 U.S.C. §119(e) to U.S. Provisional Patent Application No. 62/016,088, titled Systems and Methods for E-Prescription Pre-destination Evaluation, Editing, and Messaging, which was filed on Jun. 23, 2014, the entire contents of which are hereby incorporated herein by reference for all purposes.

### TECHNICAL FIELD

Aspects of the disclosure relate generally to the evaluation of e-prescription transactions, and more particularly, to systems and methods for evaluating, editing, rejecting and/or messaging originators of e-prescription transactions prior to delivering the transactions on for fulfillment.

### BACKGROUND

In the current environment, using a prescription as an example, a pharmacy or other ultimate destination of an e-prescription transaction, may have to request a clarification of the prescription or request to alter the prescription because, for example i) the prescription is incomplete, ii) there are errors within the prescription, iii) there are inconsistencies within the prescription, or iv) the pharmacy may have additional information that is not available to the prescriber or other originator of the e-prescription transaction. Upon receipt of the notification from the pharmacy, such as via a phone call, the prescriber may alter the original prescription, discontinue the order, or provide an explanation for the current order to the pharmacy. It can take significant time for the pharmacy to reach the prescriber and receive the necessary information from the prescriber. This additional time creates inefficiencies in the filling process and can result in safety/health issues for the patient (due to errors, inconsistencies, lack of information in the prescription and/or the patient leaving the pharmacy without getting the prescription filled. Upon receipt, the prescriber may alter the original prescription, discontinue the order, or provide an explanation for the current order. The current solution is inefficient if the quality and/or the richness of the transaction data can be improved via automation.

### BRIEF DESCRIPTION OF THE DRAWINGS

Reference will now be made to the accompanying drawings, which are not necessarily drawn to scale, and wherein:

FIG. 1 illustrates an example overview of a system that facilitates evaluating, editing, rejecting, and/or messaging back to originators of e-prescription transactions prior to transmitting the transaction or a revised transaction from the originators of the e-prescription transaction to its ultimate destination, according to one exemplary embodiment of the disclosure.

FIG. 2A is a diagram of an example data flow for evaluating, editing, rejecting, and/or messaging back to originators of e-prescription transactions prior to transmitting the transaction or a revised transaction from the originators of the e-prescription transaction to its ultimate destination as part of the processing of the e-prescription transaction, according to one exemplary embodiment of the disclosure.

FIG. 2B is a diagram of another example data flow for evaluating, editing, rejecting, and/or messaging back to originators of e-prescription transactions prior to transmitting the transaction or a revised transaction from the originators of the e-prescription transaction to its ultimate destination as part of the processing of the e-prescription transaction processed through one or more service providers, according to an alternative exemplary embodiment of the disclosure.

FIG. 3 is a flow chart of an example method for evaluating, editing, rejecting, and/or messaging back to originators of e-prescription transactions prior to transmitting the transaction or a revised transaction from the originators of the e-prescription transaction to its ultimate destination as part of the processing of the e-prescription transaction, according to one exemplary embodiment of the disclosure.

FIG. 4 is a diagram of an example data flow for evaluating, editing, rejecting, and/or messaging back to originators of e-prescription transactions, such as refill request transactions, prior to transmitting the transaction or a revised transaction from the originators of the e-prescription transaction to its ultimate destination as part of the processing of the e-prescription transaction, according to one exemplary embodiment of the disclosure.

FIG. 5 is a flow chart of an example method for evaluating, editing, rejecting, and/or messaging back to originators of e-prescription transactions, such as refill request transactions, prior to transmitting the transaction or a revised transaction from the originators of the e-prescription transaction to its ultimate destination as part of the processing of the e-prescription transaction, according to one exemplary embodiment of the disclosure.

### DETAILED DESCRIPTION OF EXEMPLARY EMBODIMENTS

Exemplary embodiments will now be described more fully hereinafter with reference to the accompanying drawings, in which exemplary embodiments are shown. The concepts disclosed herein may, however, be embodied in many different forms and should not be construed as limited to the exemplary embodiments set forth herein; rather, these embodiments are provided so that this disclosure will be thorough and complete, and will fully convey the scope of the concepts to those skilled in the art. Like numbers refer to like, but not necessarily the same or identical, elements throughout.

Exemplary embodiments described herein include systems and methods that facilitate evaluating, editing, rejecting, and/or messaging back to originators of e-prescription transactions prior to transmitting the transaction to its ultimate destination as part of the processing of the e-prescription transaction in real-time or near real-time. In one example, a prescription can be a medication, product/device, or service order (for a service to be provided to a patient), and a prescriber of medications, products, and/or services to patients, such as a physician, physician's assistant, nurse, or any other person permitted to prescribe medication or prescribe or provide healthcare services to a patient, can transmit an e-prescription transaction, via a prescriber/provider computer, to a service provider computer for ultimate submission to a pharmacy computer. The e-prescription transaction can be an e-prescription transaction for a prescribed medication, product, or service for a patient. Examples of e-prescription transactions include a new prescription transaction (providing a prescription for a medication, product, or service for a patient—transmitted from the prescriber computer through the service provider computer and to the pharmacy computer), a refill request transaction (requesting additional refills of a prescribed medication, product, or service, for a patient—transmitted from the pharmacy computer through the service provider computer and to the prescriber computer), a response to the refill request transaction (transmitted from the prescriber computer through the service provider computer and to the pharmacy computer), a product change request transaction (requesting a change to the prescribed product identified in the prescription—transmitted from the pharmacy computer through the service provider computer and to the prescriber computer), a response to the product change request transaction (transmitted from the prescriber computer through the service provider computer and to the pharmacy computer), a cancel prescription request transaction (to cancel a prescription for a patient—transmitted from the prescriber computer through the service provider computer and to the pharmacy computer), a response to the cancel prescription request transaction (transmitted from the pharmacy computer through the service provider computer and to the prescriber computer), error messages, and status messages.

The e-prescription transaction can be received by the service provider computer, which can parse and evaluate the contents of e-prescription transaction. Based on the evaluation of the e-prescription transaction, the service provider computer can determine any errors, issues, or additional information or testing related to the medication, product, or service being requested in the transaction. The service provider computer can generate a response to the e-prescription transaction that identifies the errors, issues, or additional information needed in relation to the e-prescription transaction. This response can be inserted into a message field of the e-prescription transaction or can be a separate message from the transaction. In addition, the message can be accompanied by a reject or issue code that can be included in a predetermined field of the e-prescription transaction or can be included with the message separate from the transaction. Further, the message can include an override code that can be inserted by the prescriber when the e-prescription transaction is resubmitted. The response can be transmitted by the service provider computer back to the prescriber/provider computer.

The prescriber can modify the e-prescription transaction to clarify errors or issues and/or to provide the additional information needed and can resubmit the modified e-prescription transaction to the service provider computer via the prescriber/provider computer. The service provider computer can receive the modified e-prescription transaction and can determine that no additional errors, issues, or additional information needs remain and can deliver/transmit the modified e-prescription transaction to the pharmacy computer for filling.

System Overview

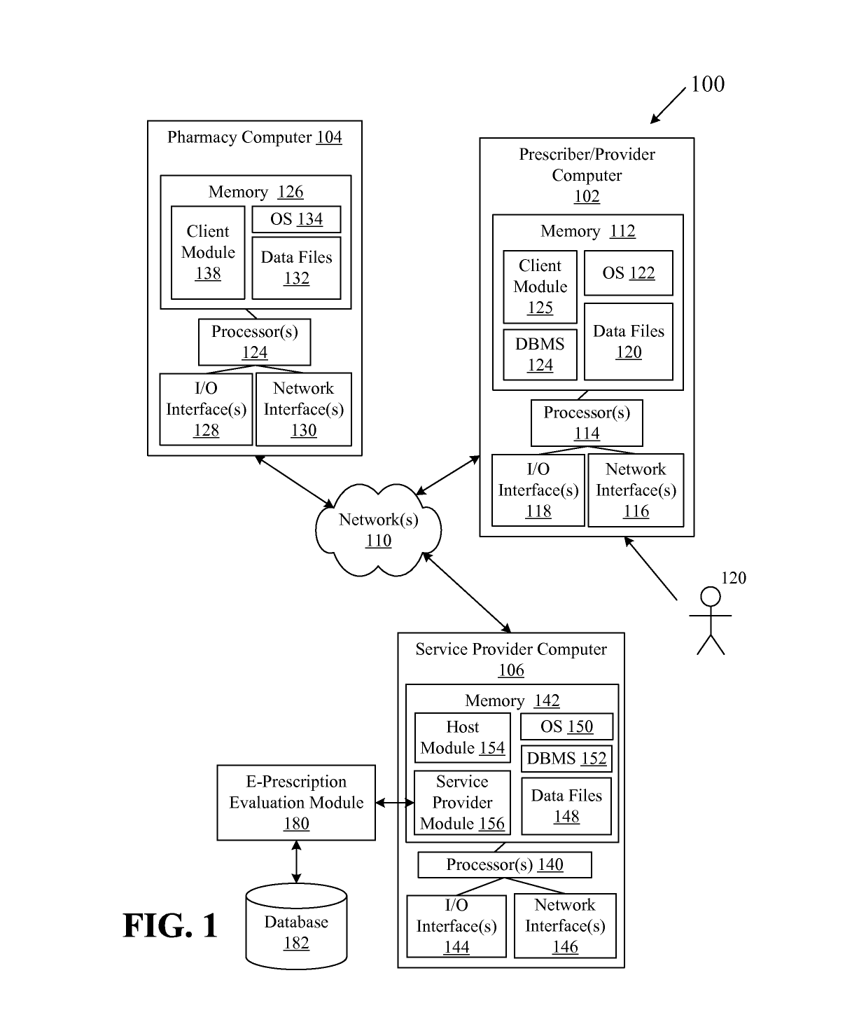

FIG. 1 illustrates an example system 100 supporting electronic prescription transaction activities according to one example embodiment. The exemplary system 100 facilitates evaluating, editing, rejecting, and/or messaging back to originators of e-prescription transactions prior to transmitting the transaction or a revised transaction from the originator of the e-prescription transaction to its ultimate destination and as part of the processing of the e-prescription transaction, including, but not limited to, an electronic prescription transaction transaction, e-script, refill request transaction, or e-prescription, and will now be described illustratively with respect to FIG. 1. As shown in FIG. 1, the system 100 may include at least one prescriber/provider computer 102, at least one pharmacy computer 104, and at least one service provider computer 106.

As desired, each of the prescriber/provider computers 102, pharmacy computers 104, and service provider computers 106 may include one or more processing devices that may be configured for accessing and reading associated computer-readable media having stored thereon data and/or computer-executable instructions for implementing various methods, including those described herein. Additionally, in certain exemplary embodiments, the service provider computer 106 may be in communication with one or more e-prescription evaluation modules 180, which may access and/or be in communication with one or more suitable data storage devices, such as database 182. The e-prescription evaluation module 180 may receive e-prescription transactions for all or a portion of the data from e-prescription transactions from the service provider computer 106. Upon receipt of the e-prescription transaction data, the e-prescription evaluation module 180 may evaluate the data to determine if there are any errors. The e-prescription evaluation module 180 may also evaluate the data to determine if any of the data is outside of threshold parameters, such as dosage, days' supply, number of refills. The e-prescription evaluation module 180 can further evaluate the data, including the medication identifier or service identifier for the medication or service requested in the transaction to determine any risk evaluation and mitigation strategies (REMS) opportunities or medication therapy management (MTM) service opportunities for the medication or service. This can include, for example, any tests the patient may need prior to receiving the requested medication or service or any comprehensive medication review (CMR), drug regimen review (DRR), medication regimen review (MRR), targeted medication review (TMR), and so forth that should be completed prior to the patient being prescribed the medication or service identified in the e-prescription transaction. If any errors or issues are identified by the e-prescription evaluation module 180, it can generate a response message and/or rejection message that identifies the errors or issues and that can be transmitted back to the prescriber/provider computer 102 from which the e-prescription transaction originated. The response/rejection message can include a rejection code or other information that can be inserted into the e-prescription transaction or can be provided separate from the e-prescription transaction. Further, the response/rejection message can include an override code that can be included in a subsequent e-prescription transaction by the prescriber to continue normal processing of the transaction without substantive evaluation by the e-prescription evaluation module 180.

Generally, network devices and systems, including one or more of the prescriber/provider computers 102, the pharmacy computers 104, service provider computer 106, and e-prescription evaluation module 180 may include or otherwise be associated with suitable hardware and/or software for transmitting and receiving data and/or computer-executable instructions over one or more communications links or networks. These network devices and systems may also include any number of processors for processing data and executing computer-executable instructions, as well as other internal and peripheral components that are well known in the art. Further, these network devices and systems may include or be in communication with any number of suitable memory devices operable to store data and/or computer-executable instructions. By executing computer-executable instructions, each of the network devices may form a special purpose computer or particular machine. As used herein, the term “computer-readable medium” describes any form of suitable memory or memory device.

As shown in FIG. 1, the prescriber/provider computers 102, pharmacy computers 104, service provider computer 106, and e-prescription evaluation module 180 may be in communication with each other via one or more networks, such as network 110, which as described below can include one or more separate or shared private and public networks, including the Internet or a publicly switched telephone network. Each of these components—the prescriber/provider computers 102, the pharmacy computers 104, the service provider computer 106, the e-prescription evaluation module 180, and the network 110 will now be discussed in further detail.

Each prescriber/provider computer 102 may be associated with a prescriber of medications, products and/or services to patients (e.g., a physician, physician's assistant, nurse, nurse practitioner, or any other person permitted to prescribe medications, products, and/or services to patients) and/or other providers of healthcare services to patients. It should be understood that more than one prescriber or provider may be associated with one prescriber/provider computer 102, as may be the case at a hospital, clinic or group physician practice. While the exemplary prescriber/provider computer 102 reference a prescriber of medication this is for example only and is not intended to be limiting in any manner. The prescriber/provider computer 102 may be any suitable processor-driven device that facilitates the generation and processing of healthcare requests, such as e-prescription transactions, made by prescribers or providers and the communication of the e-prescription transactions and/or information associated with e-prescription transactions to the service provider computer 106, such as a server computer, a mainframe computer, one or more networked computers, a desktop computer, a personal computer, a digital assistant, a personal digital assistant, a digital tablet, an Internet appliance, an application-specific circuit, microcontroller, minicomputer, or any other processor-based device. In certain example embodiments, the prescriber/provider computer 102 may be a suitable personal computer or laptop computer associated with (e.g., located within) a prescriber's practice. The execution of the computer-implemented instructions by the prescriber/provider computer 102 may form a special purpose computer or other particular machine that is operable to facilitate the generation and processing of healthcare requests, including e-prescription transactions, for patients and the communication of the e-prescription transactions and/or information associated with e-prescription transactions to a service provider computer 106. Additionally, in certain example embodiments of the disclosure, the operations and/or control of each prescriber/provider computer 102 may be distributed amongst several processing components.

In addition to the prescriber/provider computer 102 having one or more processors 114, the prescriber/provider computer 102 may also include one or more memory devices 112, one or more input/output (“I/O”) interfaces 118, and one or more network interfaces 116. The memory devices 112 may be any suitable memory device, for example, caches, read-only memory devices, random access memory devices, magnetic storage devices, removable storage devices, etc. The memory devices 112 may store data, executable instructions, and/or various program modules utilized by the prescriber/provider computer 102, for example, data files 120, an operating system (“OS”) 122, and/or a client module 125. The data files 120 may include any suitable data that facilitates the generation and/or processing of e-prescription transactions by the prescriber/provider computer 102 and the transmission of e-prescription transactions that are communicated to the service provider computer 106. For example, the data files 120 may include, but are not limited to, healthcare information and/or contact information associated with one or more patients, information associated with the particular prescriber/provider and/or the respective prescriber/provider computer 102, information associated with the service provider computer 106, information associated with one or more pharmacies and/or pharmacy computers 104, and/or information associated with one or more healthcare transactions, including e-prescription transactions. The OS 122 may be any suitable software module that controls the general operation of the prescriber/provider computer 102. The OS 122 may also facilitate the execution of other software modules by the one or more processors 114, for example, the client module 125. The OS 122 may be any currently existing or future-developed operating system including, but not limited to, Microsoft Windows®, Apple OSX™, Linux, Unix, or a mainframe operating system.

The client module 125 may be, for example, an Internet browser or other suitable software, including a dedicated program, for interacting with the service provider computer 106. For example, a user 120, such as a prescriber or employee of the prescriber may utilize the client module 125 in generating and transmitting an e-prescription transaction, such as an electronic prescription transaction, e-script, refill request transaction, or e-prescription, to the service provider computer 106. The prescriber/provider computer 102 may also utilize the client module 125 to retrieve or otherwise receive data, messages, or responses from the service provider computer 106 and/or other components of the system 100.

The one or more I/O interfaces 118 may facilitate communication between the prescriber/provider computer 102 and one or more input/output devices, for example, one or more user interface devices, such as, a display, keypad, control panel, touch-screen display, remote control, microphone, etc., that facilitate user interaction with the prescriber/provider computer 102. For example, the one or more I/O interfaces 118 may facilitate receipt, generation, and/or entry of information associated with an e-prescription transaction by an employee/contractor of the prescriber or provider. The one or more network interfaces 116 may facilitate connection of the prescriber/provider computer 102 to one or more suitable networks, for example, the network 110 illustrated in FIG. 1. In this regard, the prescriber/provider computer 102 may transmit, receive, and/or communicate information to other network components of the system 100, such as the service provider computer 106.

Each pharmacy computer 104 may be associated with a pharmacy or other healthcare provider that fills e-prescriptions for medications, products, or services for a patient, including a hospital, clinic, or hospice, etc. While the exemplary pharmacy computers 104 reference a pharmacy this is for example only and is not intended to be limiting in any manner. The pharmacy computer 104 may be any suitable processor-driven device that facilitates the processing of healthcare requests, such as e-prescription transactions, made by patients, consumers, or prescribers and the communication of information associated with e-prescription transactions to the service provider computer 106, such as a server computer, a mainframe computer, one or more networked computers, a desktop computer, a personal computer, a digital assistant, a personal digital assistant, a digital tablet, an Internet appliance, an application-specific circuit, microcontroller, minicomputer, or any other processor-based device. In certain example embodiments, the pharmacy computer 104 may be a suitable point of sale device associated with (e.g., located within) a pharmacy. The execution of the computer-implemented instructions by the pharmacy computer 104 may form a special purpose computer or other particular machine that is operable to facilitate the processing of healthcare requests, including e-prescription transactions, made by patients or received from prescribers/providers and the communication of information associated with e-prescription transactions from a service provider computer 106. Additionally, in certain example embodiments of the disclosure, the operations and/or control of each pharmacy computer 104 may be distributed amongst several processing components.

In addition to the pharmacy computer 104 having one or more processors 124, the pharmacy computer 104 may also include one or more memory devices 126, one or more input/output (“I/O”) interfaces 128, and one or more network interfaces 130. The memory devices 126 may be any suitable memory device, for example, caches, read-only memory devices, random access memory devices, magnetic storage devices, removable storage devices, etc. The memory devices 126 may store data, executable instructions, and/or various program modules utilized by the pharmacy computer 104, for example, data files 132, an operating system (“OS”) 134, and/or a client module 138. The data files 132 may include any suitable data that facilitates the receipt and/or processing of e-prescription transactions by the pharmacy computer 104 and the processing of e-prescription transactions that are communicated by the service provider computer 106. For example, the data files 132 may include, but are not limited to, healthcare information and/or contact information associated with one or more patients, information associated with the particular prescriber/provider and/or the respective prescriber/provider computer 102, information associated with the service provider computer 106, and/or information associated with one or more healthcare transactions, including e-prescription transactions. The OS 134 may be any suitable software module that controls the general operation of the pharmacy computer 104. The OS 134 may also facilitate the execution of other software modules by the one or more processors 124, for example, the client module 138. The OS 134 may be any currently existing or future-developed operating system including, but not limited to, Microsoft Windows®, Apple OSX™, Linux, Unix, or a mainframe operating system.

The client module 138 may be, for example, an Internet browser or other suitable software, including a dedicated program, for interacting with the service provider computer 106. For example, a user 120, such as a pharmacist, pharmacy assistant, or pharmacy employee may utilize the client module 138 in receiving and responding to an e-prescription transaction, such as an electronic prescription transaction, e-script, refill request transaction, or e-prescription, from the service provider computer 106. The pharmacy computer 104 may also utilize the client module 138 to retrieve or otherwise receive data, messages, or responses from the service provider computer 106 and/or other components of the system 100.

The one or more I/O interfaces 128 may facilitate communication between the pharmacy computer 104 and one or more input/output devices, for example, one or more user interface devices, such as, a display, keypad, control panel, touch-screen display, remote control, microphone, etc., that facilitate user interaction with the pharmacy computer 104. For example, the one or more I/O interfaces 128 may facilitate receipt and/or entry of information associated with an e-prescription transaction by an employee/contractor of the pharmacy. The one or more network interfaces 130 may facilitate connection of the pharmacy computer 104 to one or more suitable networks, for example, the network 110 illustrated in FIG. 1. In this regard, the pharmacy computer 104 may receive and/or communicate information to other network components of the system 100, such as the service provider computer 106.

With continued reference to FIG. 1, the service provider computer 106 may include, but is not limited to, any suitable processor-driven device that is configured for receiving, processing, and fulfilling requests from the prescriber/provider computers 102, pharmacy computers 104, and the e-prescription evaluation module 180 relating to electronic prescription submission (e.g., e-prescription transactions), other healthcare transactions, and/or other activities. In certain exemplary embodiments, the service provider computer 106 may be a switch/router that routes e-prescription transactions and other healthcare transactions. For example, the service provider computer 106 may route e prescription transactions communicated from one of the prescriber/provider computers 102 to a pharmacy computer 104.

In certain example embodiments, the service provider computer 106 may include a suitable host server, host module, or other software that facilitates the receipt of an e-prescription transaction from a prescriber/provider computer 102 and/or the routing of the received e-prescription transaction to a pharmacy computer 104. Any number of prescriber/provider computers 102, pharmacy computers 104, and e-prescription evaluation modules 180 may be in communication with the service provider computer 106 as desired in various embodiments.

The service provider computer 106 may include any number of special purpose computers or other particular machines, application-specific circuits, microcontrollers, personal computers, minicomputers, mainframe computers, servers, networked computers, and/or other processor-driven devices. In certain example embodiments, the operations of the service provider computer 106 may be controlled by computer-executed or computer-implemented instructions that are executed by one or more processors associated with the service provider computer 106 to form a special-purpose computer or other particular machine that is operable to facilitate the receipt, routing, and/or processing of e-prescription transactions. The one or more processors that control the operations of the service provider computer 106 may be incorporated into the service provider computer 106 and/or in communication with the service provider computer 106 via one or more suitable networks. In certain exemplary embodiments, the operations and/or control of the service provider computer 106 may be distributed amongst several processing components.

Similar to the pharmacy computer 104 described above, the service provider computer 106 may include one or more processors 140, one or more memory devices 142, one or more input/output (“I/O”) interface(s) 144, and one or more network interface(s) 146. The one or more memory devices 142 may be any suitable memory devices, for example, caches, read only memory devices, random access memory devices, magnetic storage devices, removable memory devices, etc. The one or more memory devices 142 may store data, executable instructions, and/or various program modules utilized by the service provider 106, for example, data files 148, an operating system (“OS”) 150, the host module 154, a service provider module 156, and a database management system (“DBMS”) 152 to facilitate management of data files 148 and other data stored in the memory devices 142. The OS 150 may be and currently existing or future-developed operating system including, but not limited to, Microsoft Windows®, Apple OSX™, Linux, Unix, or a mainframe operating system. The OS 150 may be a suitable software module that controls the general operation of the service provider computer 106 and/or that facilitates the execution of other software modules.

The service provider module 156 may be operable to perform one or more pre-edits or pre-analysis on a received e-prescription transaction prior to routing or otherwise communicating the received e-prescription transaction either back to the prescriber/provider computer 102 for further information or to a suitable pharmacy computer 104. A wide variety of different pre-edits may be performed as desired in various embodiments of the disclosure.

According to one exemplary embodiment, the data files 148 may store e-prescription transaction records associated with communications received from various prescriber/provider computers 102, the pharmacy computers 104, and the e-prescription evaluation module 180. The data files 148 may also store any number of suitable routing tables that facilitate determining the destination of communications received from a prescriber/provider computer 102, the pharmacy computer 104, and the e-prescription evaluation module 180. The exemplary data files 148 may also store records containing, for example, medication identifiers and other medication information.

The host module 154 may receive, process, and respond to requests from the client module 138 of the pharmacy computer 104 and/or the client module 125 of the prescriber computer 102. The service provider computer 106 may include additional program modules for performing other processing methods described herein. Those of ordinary skill in the art will appreciate that the service provider computer 106 may include alternate and/or additional components, hardware, or software without departing from exemplary embodiments disclosed herein.

With continued reference to the service provider computer 106, the one or more I/O interfaces 144 may facilitate communication between the service provider computer 106 and one or more input/output devices, for example, one or more user interface devices, such as a display, keypad, control panel, touch-screen display, remote control, microphone, etc. that facilitate user interaction with the service provider computer 106. The one or more network interfaces 146 may facilitate connection of the service provider computer 106 to one or more suitable networks, for example, the network 110 illustrated in FIG. 1. In this regard, the service provider computer 106 may communicate with other components of the system 100.

The e-prescription evaluation module 180 of FIG. 1 represents one or more modules that can evaluate an e-prescription transaction or data from an e-prescription transaction to determine if there are any errors, to determine if any additional information is needed, or to determine if any additional services can or may be provided by the prescriber/provider prior to sending the e-prescription transaction to the desired pharmacy, via the pharmacy computer 104. The example e-prescription evaluation module 180 may include computer-executable instructions for receiving and processing e-prescription transactions or e-prescription transaction data from a service provider computer 106. The e-prescription evaluation module 180 may receive e-prescription transactions for all or a portion of the data from e-prescription transactions from the service provider computer 106. Upon receipt of the e-prescription transaction data, the e-prescription evaluation module 180 may evaluate the data to determine if there are any errors. The e-prescription evaluation module 180 may also evaluate the data to determine if any of the data is outside of threshold parameters, such as dosage, days' supply, number of refills. The e-prescription evaluation module 180 can further evaluate the data, including the medication identifier or service identifier for the medication or service requested in the transaction to determine any risk evaluation and mitigation strategies (REMS) opportunities or medication therapy management (MTM) service opportunities for the medication or service. This can include, for example, any tests the patient may need prior to receiving the requested medication or service or any comprehensive medication review (CMR), drug regimen review (DRR), medication regimen review (MRR), targeted medication review (TMR), and so forth that should be completed prior to the patient being prescribed the medication or service identified in the e-prescription transaction. If any errors or issues are identified by the e-prescription evaluation module 180, it can generate a response message and/or rejection message that identifies the errors or issues and that can be transmitted back to the prescriber/provider computer 102 from which the e-prescription transaction originated. The response/rejection message can include a rejection code or other information that can be inserted into the e-prescription transaction or can be provided separate from the e-prescription transaction. Further, the response/rejection message can include an override code that can be included in a subsequent e-prescription transaction by the prescriber to continue normal processing of the transaction without substantive evaluation by the e-prescription evaluation module 180. The e-prescription evaluation module can communicate its analysis as well as any rejection/response messages to the service provider computer 106 or pass along the e-prescription transaction to the pharmacy computer 104.

As desired, the e-prescription evaluation module 180 may include any number of special purpose computers or other particular machines, application-specific circuits, microcontrollers, personal computers, minicomputers, mainframe computers, servers, and the like. In certain exemplary embodiments, the operations of the e-prescription evaluation module 180 may be controlled by computer-executed or computer-implemented instructions that are executed by one or more processors associated with the e-prescription evaluation module 180 to form a special purpose computer or other particular machine that is operable to facilitate the receipt, processing, and/or storage of e-prescription transactions and/or e-prescription transaction data received from the service provider computer 106. The one or more processors that control the operations of the e-prescription evaluation module 180 may be incorporated into the e-prescription evaluation module 180 and/or in communication with the e-prescription evaluation module 180 via one or more suitable networks, such as network 110. In certain example embodiments, the operations and/or control of the e-prescription evaluation module 180 may be distributed amongst several processing components.

Similar to other components of the system 100, the e-prescription evaluation module 180 may include one or more processors, one or more memory devices, one or more I/O interfaces, and one or more network interfaces. The one or more memory devices may be any suitable memory devices, for example, caches, read only memory devices, random access memory devices, magnetic storage devices, removable memory devices. The one or more memory devices may store data, executable instructions, and/or various program modules utilized by the e-prescription evaluation module 180, for example, data files, an OS, a DBMS, and a host module. The data files may include any suitable information that is utilized by the e-prescription evaluation module 180 to receive, process, analyze, and/or store e-prescription transaction data. The OS may be a suitable software module that controls the general operation of the particular e-prescription evaluation module 180. The OS may also facilitate the execution of other software modules by the one or more processors, for example, the DBMS and/or the host module. The OS may be any currently existing or future-developed operating system including, but not limited to, Microsoft Windows®, Apple OSX™, Linux, Unix, or a mainframe operating system. The DBMS may be a suitable software module that facilitates access and management of one or more databases, such as database 182, that are utilized to store information that is received by or utilized by the e-prescription evaluation module 180 and/or the service provider computer 106. The host module may initiate, receive, process, analyze, store, and/or respond to requests, such as the receipt of e-prescription transactions or e-prescription transaction data from the host module 154 of the service provider computer 106. The e-prescription evaluation module 180 may include additional program modules as desired. Those of ordinary skill in the art will appreciate that the e-prescription evaluation module 180 may include alternate and/or additional components, hardware or software without departing from example embodiments disclosed herein.

The one or more I/O interfaces may facilitate communication between the e-prescription evaluation module 180 and one or more input/output devices, for example, one or more user interface devices, such as a display, keypad, control panel, touch-screen display, remote control, microphone, etc. that facilitate user interaction with the e-prescription evaluation module 180. The one or more network interfaces may facilitate connection of the e-prescription evaluation module 180 to one or more suitable networks, for example, the network 110 illustrated in FIG. 1. In this regard, the e-prescription evaluation module 180 may receive e-prescription transactions, e-prescription transaction data, and/or other communications from the service provider computer 106. While FIG. 1 shows the e-prescription evaluation module 180 as being separate from the service provider computer 106, in certain example embodiments, the e-prescription evaluation module 180 is part of the service provider computer 106 and sending and receiving between the two are internal communications within the service provider computer 106.

The database(s) 182 may be operable to store information associated with various patients and/or various e-prescription transactions including, but not limited to, patient identification data (e.g., patient first name, patient last name, patient social security number or HICN number, cardholder ID and/or person code for the patient), tables, schedules, or lists of medications, products, and services along with corresponding service and medication identifiers (e.g., the related NDC code or RxNorm number for the medication, product, or service) that provide any prerequisite tests, information, or notifications and/or any MTM, or REMS services associated with those corresponding medications, products, and/or services, tables, schedules, or lists of pharmacy identifiers (e.g., pharmacy name or NPI number) for pharmacies and the associated pharmacy computer 104, tables, schedules, or lists of prescriber and/or provider identifiers (e.g., NPI number, DEA number, prescriber name) for prescribers and/or providers of medications and services as well as the corresponding prescriber/provider computer 102 associated with the prescriber or provider. The data in the database 182 may be accessed and evaluated by the e-prescription evaluation module 180 and/or the service provider computer 106.

The network 110 may include any telecommunication and/or data network, whether public, private, or a combination thereof, including a local area network, a wide area network, an intranet, the Internet, intermediate hand-held data transfer devices, and/or any combination thereof and may be wired and/or wireless. The network 110 may also allow for real-time, off-line, and/or batch transactions to be transmitted between or among the prescriber/provider computer 102, the pharmacy computer 104, the service provider computer 106, and the e-prescription evaluation module 180. Due to network connectivity, various methodologies, as described herein may be practiced in the context of distributed computing environments. Although the service provider computer 106 is shown for simplicity as being in communication with the prescriber/provider computer 102, the pharmacy computer 104, and the e-prescription evaluation module 180 via one intervening network 110, it is to be understood that any other network configuration is possible. For example, intervening network 110 may include a plurality of networks, each with devices such as gateways and routers for providing connectivity between or among networks 110. Instead of or in addition to a network 110, dedicated communication links may be used to connect the various devices in accordance with an example embodiment. For example, the service provider computer 106 may form the basis of network 110 that interconnects one or more of the prescriber/provider computer 102, the pharmacy computer 104, and the e-prescription evaluation module 180.

Those of ordinary skill in the art will appreciate that the system 100 shown in and described with respect to FIG. 1 is provided by way of example only. Numerous other operating environments, system architectures, and device configurations are possible. Other system embodiments can include fewer or greater numbers of components and may incorporate some or all of the functionality described with respect to the system components shown in FIG. 1. For example, in one exemplary embodiment, the service provider computer 106 (or other computer) may be implemented as a specialized processing machine that includes hardware and/or software for performing the methods described herein. In addition, at least a portion of the processor and/or processing capabilities of the service provider computer 106 may be implemented as part of the prescriber/provider computer 102 or the pharmacy computer 104. In addition, at least a portion of the processor and/or processing capabilities of the prescriber/provider computer 102, and/or the pharmacy computer 104 may be implemented as part of the service provider computer 106. Accordingly, the exemplary embodiments described herein should not be construed as being limited to any particular operating environment, system architecture, or device configuration.

Operational Overview

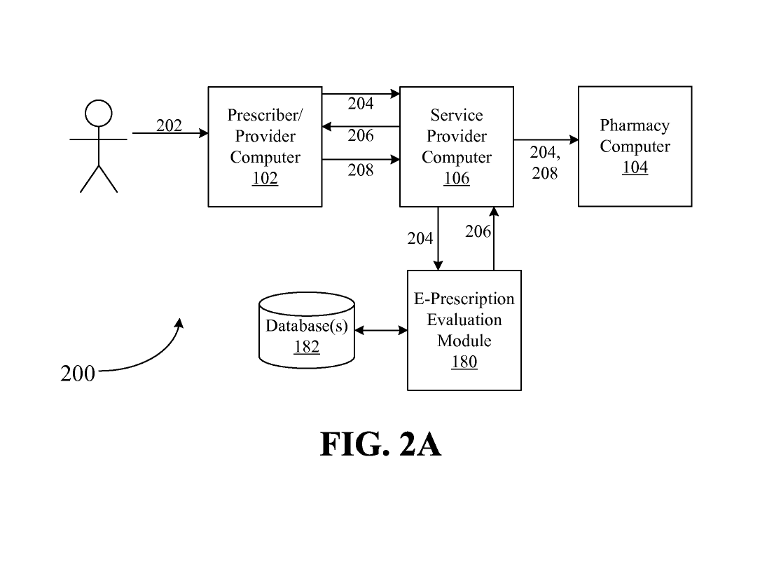

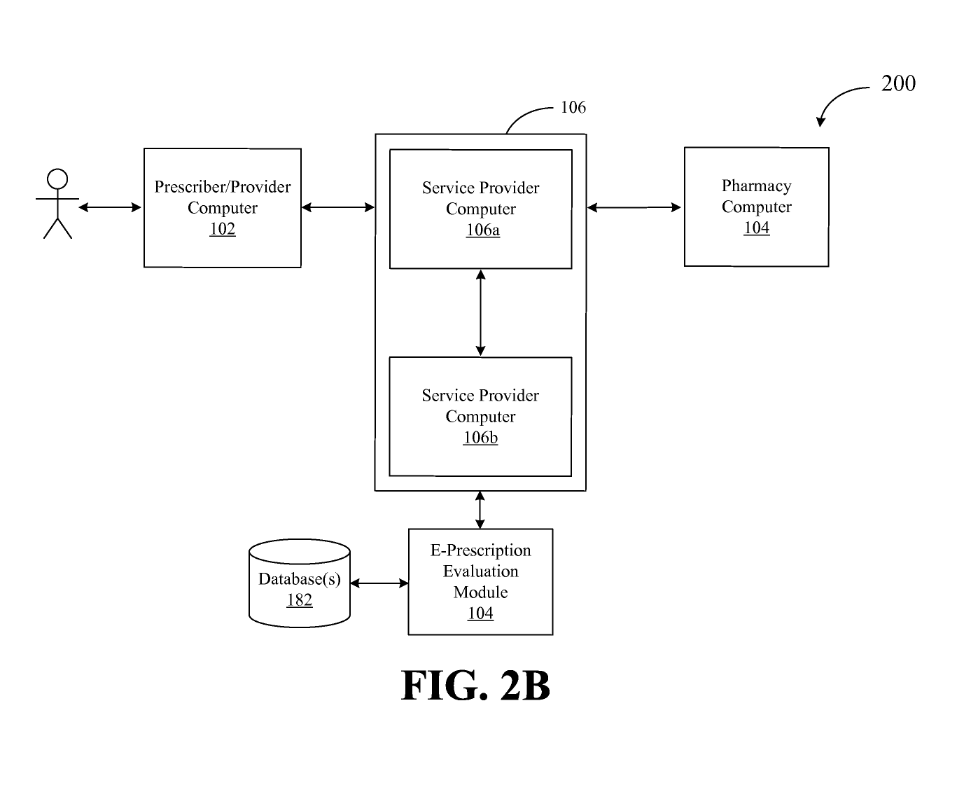

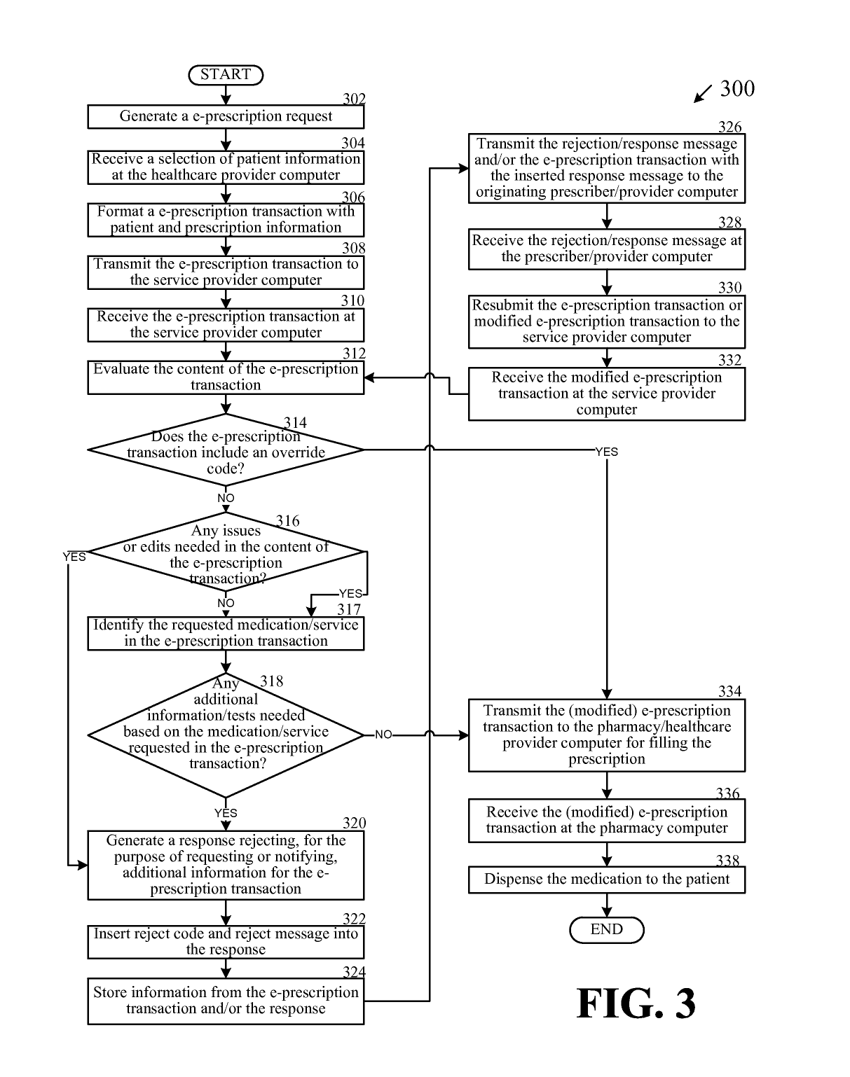

FIG. 2A is a diagram of one example data flow 200 for evaluating, editing, rejecting, and/or messaging back to originators of e-prescription transactions prior to transmitting the transaction or a revised transaction from the originator of the e-prescription transaction to its ultimate destination as part of the processing of the e-prescription transaction through a service provider computer, such as through the service provider computer 106 illustrated in FIG. 1. FIG. 3 is a flow chart of an example method 300 for evaluating, editing, rejecting, and/or messaging back to originators of e-prescription transactions prior to transmitting the transaction or a revised transaction from the originator of the e-prescription transaction to its ultimate destination as part of the processing of the e-prescription transaction, (such as an electronic prescription transaction, e-script, refill request transaction, or e-prescription) for that patient through a service provider computer 106, in accordance with one exemplary embodiment. All or a portion of the steps in the exemplary method 300, described below, may be performed by a suitable service provider computer 106 or e-prescription evaluation module 180. The exemplary method 300 will be described with reference to a physician as the prescriber/provider (and accordingly a prescriber computer as the prescriber/provider computer 102); however, this is only for purposes of example as other healthcare prescribers and providers could be substituted for, and should each be individually read as being a part of each of these methods. As such, where the discussion of the methods below and the drawings state a physician, any other healthcare prescriber or provider could be substituted, such as a nurse, physician's assistant, nurse practitioner, hospital, physician's office, clinic, healthcare center or any other person permitted to prescribe medications, products, or services to a patient.

In addition, the exemplary method 300 will be described with reference to an e-prescription transaction (e.g., electronic prescription transaction, e-script, refill request transaction, or e-prescription); however, this also is only for purposes of example as other healthcare transactions, originating from a prescriber or healthcare medications, products, or services could be substituted for the e-prescription transaction and each form of healthcare transaction should each individually be read as being used in the method described below. Examples of e-prescription transactions include a new prescription transaction (providing a prescription for a medication, product, or service for a patient—transmitted from the prescriber computer through the service provider computer and to the pharmacy computer), a refill request transaction (requesting additional refills of a prescribed medication, product, or service, for a patient—transmitted from the pharmacy computer through the service provider computer and to the prescriber computer), a response to the refill request transaction (transmitted from the prescriber computer through the service provider computer and to the pharmacy computer), a product change request transaction (requesting a change to the prescribed product identified in the prescription-transmitted from the pharmacy computer through the service provider computer and to the prescriber computer), a response to the product change request transaction (transmitted from the prescriber computer through the service provider computer and to the pharmacy computer), a cancel prescription request transaction (to cancel a prescription for a patient—transmitted from the prescriber computer through the service provider computer and to the pharmacy computer), a response to the cancel prescription request transaction (transmitted from the pharmacy computer through the service provider computer and to the prescriber computer), error messages, and status messages.

Referring now to FIGS. 1, 2A, and 3, the exemplary method 300 begins at the START step and proceeds to step 302, where a patient visits a prescriber for a healthcare check-up 202 or other healthcare service and, in response, the prescriber, such as a physician, nurse, nurse practitioner, physician's assistant or any other person permitted to prescribe medications, products, or services to patients, can generate a first e-prescription transaction 204 at the prescriber/provider computer 102 for the patient. The physician, for example, determines the patient's name and accesses the prescriber/provider computer 102, which receives a selection of patient information from the prescriber (or an employee or contractor of the prescriber, the prescriber's practice or the employer of the prescriber) via the I/O interface 118 in step 304. For example, the physician accesses the prescriber/provider computer 102 and accesses a database of patient information, which may be stored in memory 112 or in another database either local or remote from the prescriber/provider computer 102. The physician can then select the name or other patient identification information in the patient information database that matches the name or other identification information of the patient.

In step 306, a first e-prescription transaction 204 is formatted at the prescriber/provider computer 102. In certain exemplary embodiments, the prescriber/provider computer 102 formats the first e-prescription transaction 204 with patient information (e.g., patient identifiers), pharmacy identifiers (e.g., NPI code, store name, chain identifier, pharmacy address), and medication information (e.g., medication identifiers). The information can be input into the first e-prescription transaction 204 by the physician via the I/O interface 118 or automatically retrieved and entered by the prescriber/provider computer 102 and, in certain situations, can be based at least in part on historical transaction information for the patient in the data files 120 or a database communicably coupled to the prescriber/provider computer 102. According to one example embodiment, the first e-prescription transaction 204 may be formatted in accordance with a version of the NCPDP Script Standard, although other standards, such as American National Standards Institute ASC X-12 Standard, or Health Level 7 (HL7) Standard may be utilized as well.

As discussed above, the first e-prescription transaction 204 may include a pharmacy identifier for identifying a particular pharmacy computer 104 as a destination for the first e-prescription transaction 204. In addition, the first e-prescription transaction 204 may also include information relating to the patient, payor, prescriber, healthcare provider, and/or the requested medication. As an example, the first e-prescription transaction 204 may include one or more of the following information:

Patient Information
Name (e.g. Patient Last Name, Patient First Name, etc.)
Relationship to cardholder
Date of Birth of Patient
Age of Patient
Gender of Patient
Patient Address (e.g. Street Address, City, State, Zip/Postal Code, etc.)
Patient Contact Information (e.g. Patient Telephone Number, Email Address, etc.)
Patient Health Condition Information
Patient ID or other identifier (e.g., Health Insurance Claim Number (HICN), Social Security Number, etc.)

Insurance/Coverage Information
Cardholder Name (e.g. Cardholder First Name, Cardholder Last Name)
Cardholder ID and/or other identifier (e.g. Person Code)
Group ID and/or Group Information

Prescriber Information
Prescriber ID or other identifier (e.g. NPI code, DEA number)
Prescriber Name (e.g. Last Name, First Name)
Prescriber Specialty
Prescriber Address (e.g. Street Address, City, State, Zip/Postal Code, etc.)
Clinic Name
Prescriber Contact Information (e.g. Telephone Number, Email Address, Fax Number, etc.)

Pharmacy Information
Pharmacy or other Healthcare Provider Information (e.g. Store Name, Chain Identifier, etc.)
Pharmacy or other Healthcare Provider ID (e.g. NPI code)
Pharmacist Name (e.g., Last Name, First Name)
Pharmacy Address (e.g., Street Address, City, State, Zip/Postal Code, etc.)
Pharmacy Contact Information (e.g. Telephone Number, Email Address, Fax Number, etc.)

Product/Service Information
Drug, service, or product information/identifier (e.g. Drug Name, Strength,

Formulary, National Drug Code (NDC) code, RxNorm code, etc.)
Prescription/Service Reference Number
DEA Schedule
Date Prescription Written
Quantity Dispensed
Dosage Level
Days' Supply
Diagnosis/Condition (e.g., Diagnosis Code (e.g., International Statistical Classification of Diseases and Related Health Problems (ICD) Diagnosis Code)
Number of Refills Authorized
One or more NCPDP Message Fields
Date of Service.

The first e-prescription transaction 204 can be used to transmit a prescription from a prescriber to a pharmacy for filling of the medication, product, or service identified in the prescription. The prescriber/provider computer 102 can transmit the first e-prescription transaction 204 to the service provider computer 106 in step 308. In step 310, the service provider computer 106 receives the first e-prescription transaction 204. For example, the first e-prescription transaction 204 can be transmitted by the prescriber/provider computer 102 to the service provider computer 106 through the network 110.

In step 312, the e-prescription evaluation module 180 or another portion of the service provider computer 106 evaluates the contents of the first e-prescription transaction 204. For example, the e-prescription evaluation module 180 can parse the first e-prescription transaction 204 and evaluate the e-prescription transaction data according to one or more business rules. In certain example, embodiments, the business rules used for the evaluation may vary depending on the prescriber it was received from or the pharmacy that it will be transmitted to. As such, the e-prescription evaluation module 180 may identify the prescriber identifier (e.g., NPI number or DEA code) or the pharmacy identifier (e.g., NPI number, chain identifier, pharmacy name or pharmacy address), and compare the identified identifier to a table, schedule, or listing of identifiers to determine the particular set of business rules to use for editing, evaluating, and/or rejecting the first e-prescription transaction 204. In certain example embodiments, the evaluation of the e-prescription transaction data is conducted to determine if the data (or lack of data) creates a basis for rejection of the e-prescription transaction 204. Examples of a basis for rejection include the e-prescription transaction data containing errors, data is missing or data elements are missing from the e-prescription transaction data, an incorrect quantity of medication is being prescribed, the requested medication or product is discontinued or otherwise no longer available, due to the age and/or gender of the patient, the medication or product cannot be prescribed to that patient, based on the medication requested in the e-prescription transaction 204 additional tests for the patient are needed, or additional information is needed to be included in the transaction 204.

In step 314, an inquiry is conducted to determine if the first e-prescription transaction 204 includes an override code or some other designation or entry to provide notification that editing, evaluation, and/or rejection of the first e-prescription transaction 204 should not occur. The determination can be made, for example, by the e-prescription evaluation module 180 or another portion of the service provider computer 106. In one example embodiment, an override code can be included in an agreed upon field of the first e-prescription transaction and identified by the e-prescription evaluation module 180. The e-prescription evaluation module 180 can parse the transaction 204, identify the override code, and compare the identified override code to a schedule of one or more override codes to determine if the identified override code is a proper override code. In certain example embodiments, the override code may have been previously provided to the physician at the prescriber/provider computer 102 via a rejection and/or response message from the e-prescription evaluation module 180. If the first e-prescription transaction 204 does include a proper override code, the YES branch is followed to step 334. Otherwise, if the first e-prescription transaction 204 does not include a proper override code, the NO branch is followed to step 316.

An inquiry is conducted to determine if there are any issues or edits needed to the content of the first e-prescription transaction 204 in step 316. In one example embodiment, the determination can be made by the e-prescription evaluation module 180 or another portion of the service provider computer 106. For example, the e-prescription evaluation module 180 can evaluate one or all of the entries in the fields of the transaction 204 (e.g., depending on the particular business rules) and may determine if the first e-prescription transaction 204 is missing a prescribed quantity or some other field is missing a needed entry or the entry is the wrong format. In another example, the e-prescription evaluation module 180 can evaluate one or more fields of the transaction 204 to determine if the proposed medication dosing, days' supply, number of refills, patient age, patient gender, or total quantity of the requested medication in the first e-prescription transaction 204 exceeds the recommended/allowed guidelines for the medication. For example, the e-prescription evaluation module 180 can identify the medication identifier (e.g., NDC code) in the first e-prescription transaction 204 and can compare that to a schedule of medication identifiers in the database 182 to identify a matching record. The e-prescription evaluation module 180 can then determine prescribing recommendations/allowances (e.g., dosing amount, days' supply, number of refills, patient age, patient gender, other medications being taken by the patient, or total quantity) in the matching record and can compare the data in the fields of the first e-prescription transaction 204 to determine if one or more of the data in the fields does not satisfy (e.g., match or fall within the particular parameter) the particular recommendation/allowance for the prescribed medication. In another example, the e-prescription evaluation module 180 can evaluate the drug identifier field in the transaction 204 to determine if the NDC and RxNorm values are consistent or if they match the other drug description fields in the transaction 204. In yet another example, the e-prescription evaluation module 180 can evaluate a portion of the transaction 204 and determine if it is consistent with the content of the notes to the pharmacy presented in one of the text fields of the transaction 204. In another example, the e-prescription evaluation module 180 can compare the data in the transaction 204 to a database of stored transactions to determine if the transaction 204 is a duplicate transaction that should not be processed and should be rejected. In another example, the e-prescription evaluation module 180 can compare the one or more sender identifiers (e.g. prescriber identifier or pharmacy identifier) in the transaction 204 to determine if the transaction includes duplicate sender identifiers identifying more than one sender. In yet another example, the e-prescription evaluation module 180 can compare the one or more identifiers (e.g., transaction identifier) in the e-prescription transaction 204 to determine if the transaction 204 includes duplicate identifiers identifying two different e-prescriptions with the same identifier. In another example, the e-prescription evaluation module 180 can evaluate the fields of the transaction 204 to determine if the transaction satisfies compliance or regulatory requirements. If any errors are identified or any recommendations/allowance for the requested medication are not met or the first e-prescription transaction 204 otherwise needs edits or has issues in the content of the transaction data, the YES branch can be followed to either step 320 or step 317. In certain example embodiments, it may be desirable to immediately reject a first e-prescription transaction 204 if initial edits or issues are identified, and as such, the YES branch can be followed to step 320. Alternatively, there may be a desire to check the first e-prescription transaction 204 for additional issues and MTM or REMS opportunities that can be included in the rejection/response messaging back to the prescriber/provider computer 102, and as such, the YES branch can be followed to step 317. If there are not issues or edits needed in the content of the first e-prescription transaction 204, the NO branch is followed to step 317.

In step 317, the requested medication, product, or service in the first e-prescription transaction 204 can be identified. For example, the e-prescription evaluation module 180 or another portion of the service provider computer 106 can identify the NDC code or RxNorm number in the product field of the first e-prescription transaction 204. In step 318, an inquiry can be conducted to determine if any additional information or tests are needed based on the medication, product, or service requested in the first e-prescription transaction 204. In one example embodiment, the determination can be made by the e-prescription evaluation module 180 or another portion of the service provider computer 106. For example, the e-prescription evaluation module 180 can compare the identified medication, product, or service identifier to a table, list, or schedule of medication, product, or service identifiers in the database 182 to locate a record with a matching medication, product, or service identifier. The e-prescription evaluation module 180 can identify any additional information or tests needed based on the information in the matching record. For example, the e-prescription evaluation module 180 can evaluate the data in the matching record for any risk evaluation and mitigation strategies (REMS) opportunities (e.g., a determination that the requested medication has a REMS requirement for testing liver enzymes at defined intervals while taking the medication) or medication therapy management (MTM) service opportunities for the medication or service. This can include, for example, any tests the patient may need prior to receiving the requested medication, product, or service or any comprehensive medication review (CMR), drug regimen review (DRR), medication regimen review (MRR), targeted medication review (TMR), and so forth that should be completed prior to the patient being prescribed the medication, product, or service identified in the first e-prescription transaction 204.

If no additional tests or information are needed, such as REMS requirements or MTM opportunities, then the NO branch is followed to step 334. Otherwise, the YES branch is followed to step 320. In step 320, a response message 206 to the first e-prescription transaction 204 is generated. In one example embodiment, the response message 206 can be generated by the e-prescription evaluation module 180 or another portion of the service provider computer 106. For example, the e-prescription evaluation module 180 can generate a response 206 to the first e-prescription transaction 204 that identifies the errors, issues, or additional information needed in relation to the first e-prescription transaction 204. In one example embodiment, the response 206 may include a warning to the prescriber associated with the prescriber computer 102 regarding, for example, the prescribed medication, quantity, dosage, or days' supply, in the first e-prescription transaction 204. This response message 206 can be inserted into a message field of the first e-prescription transaction 204 or can be a separate message from the transaction 204.

In step 322, a reject or issue code and/or a reject or issue message that provides an indication of the reason the first e-prescription transaction 204 is being rejected and/or the response message is being sent can be inserted into the first e-prescription transaction 204 as part of the response message 206. The reject or issue code can be included in a predetermined field of the first e-prescription transaction 204 or can be included with the message 206 separate from the transaction 204. Further, the response message 206 can include an override code that can be inserted by the prescriber when the first e-prescription transaction 208 is resubmitted. The override code can be inserted by the e-prescription evaluation module 180 into a predetermined field of the first e-prescription transaction 204 or can be included separately with the response message 206. In one example embodiment, the response/rejection message 206 (hereinafter referred to as a response) to the first e-prescription transaction 204 can be generated by the e-prescription evaluation module 180 or another portion of the service provider computer 106 without sending the transaction 204 to the pharmacy computer 104.

In step 324, all or a portion of the information from the first e-prescription transaction 204 and/or the response to the first e-prescription transaction 206 can be stored for subsequent evaluation. For example, the information can be stored in the database 182 and/or the data files 148 and can include, but is not limited to, the prescription number, the medication identifier, the one or more patient identifiers, and the pharmacy identifier. In one example embodiment, the information from the first e-prescription transaction 204 and/or the response 206 can be stored by the e-prescription evaluation module 180 or another portion of the service provider computer 106. In step 326, the response to the first e-prescription transaction 206 can be transmitted to the prescriber/provider computer 102. For example, the service provider computer 106 can transmit the response 206 via the network 110 to the prescriber/provider computer 102.

The prescriber/provider computer 102 can receive the response to the first e-prescription transaction 206, which includes the rejection/response message by the service provider computer 106, in step 328. In step 330, the physician or other prescriber can generate a modified e-prescription transaction 208 and the prescriber/provider computer 102 can transmit the modified e-prescription transaction 208 to the service provider computer 106 via, for example, the network 110. For example, the modified e-prescription transaction 208 can include the override code that was previously provided to the prescriber/provider computer 102 in the response to the first e-prescription transaction 206. In this example, the override code can be placed into an agreed upon field of the modified e-prescription transaction 208. Further, in certain example embodiments, the prescription number, medication identifier, pharmacy identifier, and one or more patient identifiers in the modified e-prescription transaction 208 and the first e-prescription transaction 204 can be the same. In step 332, the service provider computer 106 receives the modified e-prescription transaction 208 from the prescriber/provider computer 102. The process can then return to step 312, where all or a portion of steps 312-332 may be repeated for the modified e-prescription transaction 208 in a manner substantially the same as that discussed above for the first e-prescription transaction 204, as one of ordinary skill in the art will recognize.

The service provider computer 106 can transmit the first e-prescription transaction 204 or the modified e-prescription transaction 208 to the pharmacy computer 104 in step 334. For example, a first e-prescription transaction 204 or modified e-prescription transaction 208 can be transmitted from the service provider computer 106 to the pharmacy computer 104 via the network 110. The pharmacy computer 104 receives the first e-prescription transaction 204 or the modified e-prescription transaction 208 in step 336. In step 338, the pharmacy, such as a pharmacist or other pharmacy employee can dispense the medication or product or can provide the service to the patient based on information in the first e-prescription transaction 204 or the modified e-prescription transaction 208. The process then continues to the END step.

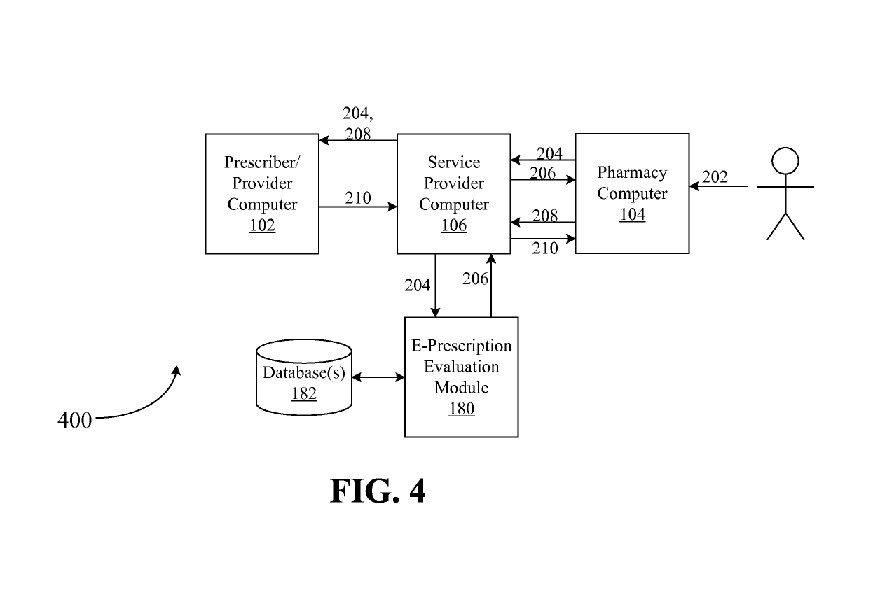

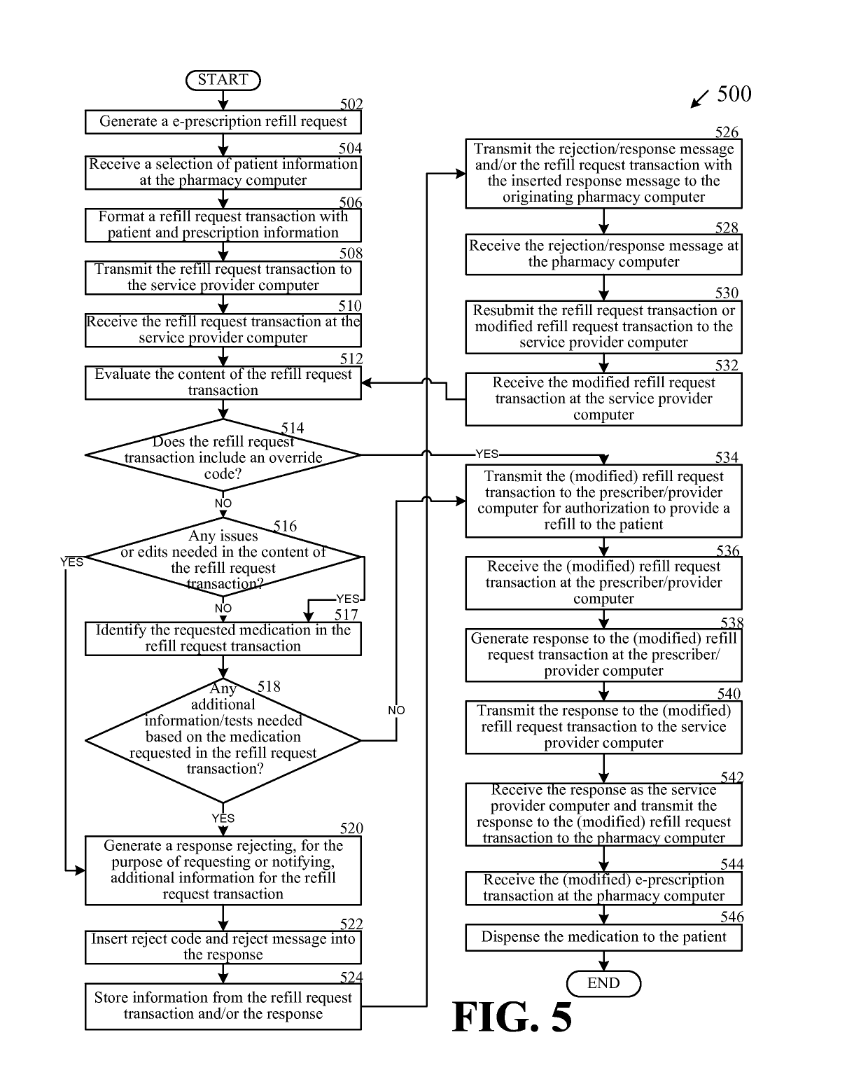

FIG. 4 is a diagram of another example data flow 400 for evaluating, editing, rejecting, and/or messaging back to originators of e-prescription transactions prior to transmitting the transaction or a revised transaction from the originator of the e-prescription transaction to its ultimate destination as part of the processing of the e-prescription transaction through a service provider computer, such as through the service provider computer 106 illustrated in FIG. 1. FIG. 5 is a flow chart of another example method 500 for evaluating, editing, rejecting, and/or messaging back to originators of e-prescription transactions prior to transmitting the transaction or a revised transaction from the originator of the e-prescription transaction to its ultimate destination as part of the processing of the e-prescription transaction originating from a pharmacy computer (such as a refill request transaction) for that patient through a service provider computer 106, in accordance with one exemplary embodiment. All or a portion of the steps in the exemplary method 500, described below, may be performed by a suitable service provider computer 106 or e-prescription evaluation module 180. The exemplary method 500 will be described with reference to a pharmacy as a healthcare provider and a physician as a prescriber/provider (and accordingly a pharmacy computer and a prescriber computer respectively as the pharmacy computer 104 and prescriber/provider computer 102 respectively); however, this is only for purposes of example as other healthcare providers (e.g., clinic, hospital, mail-order pharmacy, pharmacy, etc.) and other healthcare prescribers and providers could be substituted for, and should each be individually read as being a part of each of these methods. As such, where the discussion of the methods below and the drawings state a physician, any other healthcare prescriber or provider could be substituted, such as a nurse, physician's assistant, nurse practitioner, hospital, physician's office, clinic, healthcare center or any other person permitted to prescribe medications, products, or services to a patient. Further, where the discussion of the methods below and the drawings state a pharmacy, any other healthcare provider could be substituted, such as a hospital, clinic, hospice facility or mail order clinic.

In addition, the exemplary method 500 will be described with reference to a refill request transaction as the e-prescription transaction; however, this also is only for purposes of example as other e-prescription transactions (e.g., a new prescription transaction (providing a prescription for a medication, product, or service for a patient—transmitted from the prescriber computer through the service provider computer and to the pharmacy computer), a response to the refill request transaction (transmitted from the prescriber computer through the service provider computer and to the pharmacy computer), a product change request transaction (requesting a change to the prescribed product identified in the prescription-transmitted from the pharmacy computer through the service provider computer and to the prescriber computer), a response to the product change request transaction (transmitted from the prescriber computer through the service provider computer and to the pharmacy computer), a cancel prescription request transaction (to cancel a prescription for a patient—transmitted from the prescriber computer through the service provider computer and to the pharmacy computer), a response to the cancel prescription request transaction (transmitted from the pharmacy computer through the service provider computer and to the prescriber computer), error messages, and status messages) could be substituted for the refill request transaction and each form of e-prescription transaction should each individually be read as being used in the method described below.

Referring now to FIGS. 1, 4, and 5, the exemplary method 500 begins at the START step and proceeds to step 502, where a patient visits a pharmacy to request 402 a refill for a medication or product. In response, the pharmacist or other pharmacy employee can generate a first refill request transaction 404 at the pharmacy computer 104 for the patient. The pharmacist, for example, determines the patient's name and accesses the pharmacy computer 104, which receives a selection of patient information from the pharmacist (or an employee or contractor of the pharmacist) via the I/O interface 128 in step 504. For example, the pharmacist accesses the pharmacy computer 104 and accesses a database of patient information, which may be stored in memory 126 or in another database either local or remote from the pharmacy computer 104. The pharmacist can then select the name or other patient identification information in the patient information database that matches the name or other identification information of the patient.

In step 506, a first refill request transaction 404 is formatted at the pharmacy computer 104. In certain exemplary embodiments, the pharmacy computer 104 formats the first refill request transaction 404 with patient information (e.g., patient identifiers), prescriber identifiers (e.g., NPI code, or DEA number), and medication information (e.g., medication identifiers). The information can be input into the first refill request transaction 404 by the pharmacist via the I/O interface 128 or automatically retrieved and entered by the pharmacy computer 104 and, in certain situations, can be based at least in part on historical transaction information for the patient in the data files 132 or a database communicably coupled to the pharmacy computer 104. According to one example embodiment, the first refill request transaction 404 may be formatted in accordance with a version of the NCPDP Script Standard, although other standards, such as American National Standards Institute (ANSI) ASC X-12 Standard, or Health Level 7 (HL7) Standard may be utilized as well.

As discussed above, the first refill request transaction 404 may include a prescriber identifier for identifying a particular prescriber/provider computer 104 as a destination for the first refill request transaction 404. In addition, the first refill request transaction 404 may also include information relating to the patient, payor, pharmacy, healthcare provider, and/or the requested medication. As an example, the first refill request transaction 404 may include one or more of the following information:

Patient Information
Name (e.g. Patient Last Name, Patient First Name, etc.)
Relationship to cardholder
Date of Birth of Patient
Age of Patient
Gender of Patient
Patient Address (e.g. Street Address, City, State, Zip/Postal Code, etc.)
Patient Contact Information (e.g. Patient Telephone Number, Email Address, etc.)
Patient Health Condition Information
Patient ID or other identifier (e.g., Health Insurance Claim Number (HICN), Social Security Number, etc.)

Insurance/Coverage Information
Cardholder Name (e.g. Cardholder First Name, Cardholder Last Name)
Cardholder ID and/or other identifier (e.g. Person Code)
Group ID and/or Group Information

Prescriber Information
Prescriber ID or other identifier (e.g. NPI code, DEA number)
Prescriber Name (e.g. Last Name, First Name)
Prescriber Specialty
Prescriber Address (e.g. Street Address, City, State, Zip/Postal Code, etc.)
Clinic Name
Prescriber Contact Information (e.g. Telephone Number, Email Address, Fax Number, etc.)

Pharmacy Information
Pharmacy or other Healthcare Provider Information (e.g. Store Name, Chain Identifier, etc.)
Pharmacy or other Healthcare Provider ID (e.g. NPI code)
Pharmacist Name (e.g., Last Name, First Name)
Pharmacy Address (e.g., Street Address, City, State, Zip/Postal Code, etc.)
Pharmacy Contact Information (e.g. Telephone Number, Email Address, Fax Number, etc.)

Product/Service Information
Drug, service, or product information/identifier (e.g. Drug Name, Strength, Formulary, National Drug Code (NDC) code, RxNorm code, etc.)
Prescription/Service Reference Number
DEA Schedule
Date Prescription Written
Quantity Dispensed
Dosage Level
Days' Supply
Diagnosis/Condition (e.g., Diagnosis Code (e.g., International Statistical Classification of Diseases and Related Health Problems (ICD) Diagnosis Code)
Number of Refills Authorized
One or more NCPDP Message Fields
Date of Service.

The first refill request transaction 404 can be used to transmit a refill request for a prescription from a pharmacy to a prescriber for authorization, and then back to the pharmacy for filling of the medication, product, or service identified in the first refill request transaction 404. The pharmacy computer 104 can transmit the first refill request transaction 404 to the service provider computer 106 in step 508. In step 510, the service provider computer 106 receives the first refill request transaction 404. For example, the first refill request transaction 404 can be transmitted by the pharmacy computer 104 to the service provider computer 106 through the network 110.

In step 512, the e-prescription evaluation module 180 or another portion of the service provider computer 106 evaluates the contents of the first refill request transaction 404. For example, the e-prescription evaluation module 180 can parse the first refill request transaction 404 and evaluate the refill request transaction data according to one or more business rules. In certain example, embodiments, the business rules used for the evaluation may vary depending on the pharmacy it was received from or the prescriber that it will be transmitted to. As such, the e-prescription evaluation module 180 may identify the prescriber identifier (e.g., NPI number or DEA code) or the pharmacy identifier (e.g., NPI number, chain identifier, pharmacy name or pharmacy address) and compare the identified identifier to a table, schedule, or listing of identifiers to determine the particular set of business rules to use for editing, evaluating, and/or rejecting the first refill request transaction 204. In certain example embodiments, the evaluation of the refill request transaction data is conducted to determine if the data (or lack of data) creates a basis for rejection of the refill request transaction 404. Examples of a basis for rejection include the e-prescription transaction data containing errors, data is missing or data elements are missing from the e-prescription transaction data, an incorrect quantity of medication is being prescribed, the requested medication or product is discontinued or otherwise no longer available, due to the age and/or gender of the patient, the medication or product cannot be prescribed to that patient, based on the medication requested in the e-prescription transaction 404 additional tests for the patient are needed, or additional information is needed to be included in the transaction 404.

In step 514, an inquiry is conducted to determine if the first refill request transaction 404 includes an override code or some other designation or entry to provide notification that editing, evaluation, and/or rejection of the first refill request transaction 404 should not occur. The determination can be made, for example, by the e-prescription evaluation module 180 or another portion of the service provider computer 106. In one example embodiment, an override code can be included in an agreed upon field of the first refill request transaction 404 and identified by the e-prescription evaluation module 180. The e-prescription evaluation module 180 can parse the transaction 404, identify the override code, and compare the identified override code to a schedule of one or more override codes to determine if the identified override code is a proper override code. In certain example embodiments, the override code may have been previously provided to the pharmacy at the pharmacy computer 104 via a rejection and/or response message from the e-prescription evaluation module 180. If the first refill request transaction 404 does include a proper override code, the YES branch is followed to step 534. Otherwise, if the first refill request transaction 404 does not include a proper override code, the NO branch is followed to step 516.

An inquiry is conducted to determine if there are any issues or edits needed to the content of the first refill request transaction 404 in step 516. In one example embodiment, the determination can be made by the e-prescription evaluation module 180 or another portion of the service provider computer 106. For example, the e-prescription evaluation module 180 can evaluate one or more of the entries in the fields of the transaction 404 (e.g., depending on the particular business rules) and may determine the first refill request transaction 404 is missing a prescribed quantity or some other field is missing a needed entry or the entry is the wrong format. In another example, the e-prescription evaluation module 180 can evaluate one or more fields of the transaction 404 to determine if the proposed medication dosing, days' supply, number of refills, patient age, patient gender, or total quantity of the requested medication in the first refill request transaction 404 exceeds the recommended/allowed guidelines for the medication. For example, the e-prescription evaluation module 180 can identify the medication identifier (e.g., NDC code) in the first refill request transaction 404 and can compare that to a schedule of medication identifiers in the database 182 to identify a matching record. The e-prescription evaluation module 180 can then determine prescribing recommendations/allowances (e.g., dosing amount, days' supply, number of refills, patient age, patient gender, other medications being taken by the patient, or total quantity) in the matching record and can compare the data in the fields of the first refill request transaction 404 to determine if one or more of the data in the fields does not satisfy (e.g., match or fall within the particular parameter) the particular recommendation/allowance for the prescribed medication. In another example, the e-prescription evaluation module 180 can evaluate the drug identifier field in the transaction 404 to determine if the NDC and RxNorm values are consistent or if they match the other drug description fields in the transaction 404. In another example, the e-prescription evaluation module 180 can compare the data in the transaction 404 to a database of stored transactions to determine if the transaction 404 is a duplicate transaction that should not be processed and should be rejected. In another example, the e-prescription evaluation module 180 can compare the one or more sender identifiers (e.g. prescriber identifier or pharmacy identifier) in the transaction 404 to determine if the transaction includes duplicate sender IDs for more than one sender. In yet another example, the e-prescription evaluation module 180 can compare the one or more identifiers (e.g., transaction identifier) in the first refill request transaction 404 to determine if the transaction 404 includes duplicate identifiers identifying two different e-prescriptions with the same identifier. In another example, the e-prescription evaluation module 180 can evaluate the fields of the transaction 404 to determine if the transaction satisfies compliance or regulatory requirements. If any errors are identified or any recommendations/allowance for the requested medication are not met or the first refill request transaction 404 otherwise needs edits or has issues in the content of the transaction data, the YES branch can be followed to either step 520 or step 517. In certain example embodiments, it may be desirable to immediately reject a first refill request transaction 404 if initial edits or issues are identified, and as such, the YES branch can be followed to step 520. Alternatively, there may be a desire to check the first refill request transaction 204 for additional issues and MTM or REMS opportunities that can be included in the rejection/response messaging back to the pharmacy computer 104, and as such, the YES branch can be followed to step 517. If there are not issues or edits needed in the content of the first refill request transaction 404, the NO branch is followed to step 517.

In step 517, the requested medication, product, or service in the first refill request transaction 404 can be identified. For example, the e-prescription evaluation module 180 or another portion of the service provider computer 106 can identify the NDC code or RxNorm number in the product field of the first refill request transaction 404. In step 518, an inquiry can be conducted to determine if any additional information or tests are needed based on the medication, product, or service requested in the first refill request transaction 404. In one example embodiment, the determination can be made by the e-prescription evaluation module 180 or another portion of the service provider computer 106. For example, the e-prescription evaluation module 180 can compare the identified medication, product, or service identifier to a table, list, or schedule of medication, product, or service identifiers in the database 182 to locate a record with a matching medication, product, or service identifier. The e-prescription evaluation module 180 can identify any additional information or tests needed based on the information in the matching record. For example, the e-prescription evaluation module 180 can evaluate the data in the matching record for any risk evaluation and mitigation strategies (REMS) opportunities (e.g., a determination that the requested medication has a REMS requirement for testing liver enzymes at defined intervals while taking the medication) or medication therapy management (MTM) service opportunities for the medication or service. This can include, for example, any tests the patient may need prior to receiving the requested medication, product, or service or any comprehensive medication review (CMR), drug regimen review (DRR), medication regimen review (MRR), targeted medication review (TMR), and so forth that should be completed prior to the patient being prescribed the medication, product, or service identified in the first refill request transaction 404.

If no additional tests or information are needed, such as REMS requirements or MTM opportunities, then the NO branch is followed to step 534. Otherwise, the YES branch is followed to step 520. In step 520, a response message 406 to the first refill request transaction 404 is generated. In one example embodiment, the response message 406 can be generated by the e-prescription evaluation module 180 or another portion of the service provider computer 106. For example, the e-prescription evaluation module 180 can generate a response 406 to the first refill request transaction 404 that identifies the errors, issues, or additional information needed in relation to the first refill request transaction 404. This response message 406 can be inserted into a message field of the first refill request transaction 404 or can be a separate message from the transaction 404.

In step 522, a reject or issue code and/or a reject or issue message that provides an indication of the reason the first refill request transaction 404 is being rejected and/or the response message 406 is being sent can be inserted into the first refill request transaction 404 as part of the response message 406. The reject or issue code can be included in a predetermined field of the first refill request transaction 404 or can be included with the message 406 separate from the transaction 404. Further, the response message 406 can include an override code that can be inserted by the pharmacist when the modified refill request transaction 408 is resubmitted. The override code can be inserted by the e-prescription evaluation module 180 into a predetermined field of the first refill request transaction 404 or can be included separately with the response message 406. In one example embodiment, the response/rejection message 406 (hereinafter referred to as a response) to the first refill request transaction 404 can be generated by the e-prescription evaluation module 180 or another portion of the service provider computer 106 without sending the transaction 404 to the prescriber/provider computer 102.

In step 524, all or a portion of the information from the first refill request transaction 404 and/or the response to the first refill request transaction 406 can be stored for subsequent evaluation. For example, the information can be stored in the database 182 and/or the data files 148 and can include, but is not limited to, the prescription number, the medication identifier, the one or more patient identifiers, and the pharmacy identifier. In one example embodiment, the information from the first refill request transaction 404 and/or the response 406 can be stored by the e-prescription evaluation module 180 or another portion of the service provider computer 106. In step 526, the response to the first refill request transaction 406 can be transmitted to the pharmacy computer 102. For example, the service provider computer 106 can transmit the response 406 via the network 110 to the pharmacy computer 104.

The pharmacy computer 104 can receive the response to the first refill request transaction 406, which includes the rejection/response message by the service provider computer 106, in step 528. In step 530, the pharmacist can generate a modified refill request transaction 408 and the pharmacy computer 104 can transmit the modified refill request transaction 408 to the service provider computer 106 via, for example, the network 110. For example, the modified refill request transaction 408 can include the override code that was previously provided to the pharmacy computer 104 in the response to the first refill request transaction 406. In this example, the override code can be placed into an agreed upon field of the modified refill request transaction 408. Further, in certain example embodiments, the prescription number, medication identifier, pharmacy identifier, and one or more patient identifiers in the modified refill request transaction 408 and the first refill request transaction 404 can be the same. In step 532, the service provider computer 106 receives the modified refill request transaction 208 from the pharmacy computer 104. The process can then return to step 512, where all or a portion of steps 512-532 may be repeated for the modified refill request transaction 408 in a manner substantially the same as that discussed above for the first refill request transaction 404, as one of ordinary skill in the art will recognize.

The service provider computer 106 can transmit the first refill request transaction 404 or the modified refill request transaction 408 to the prescriber/provider computer 102 in step 534. For example, a first refill request transaction 404 or modified refill request transaction 408 can be transmitted from the service provider computer 106 to the prescriber/provider computer 102 via the network 110 for authorization of the requested refill for the patient. The prescriber/provider computer 102 receives the first refill request transaction 404 or the modified refill request transaction 408 in step 536. In step 538, the prescriber, via the prescriber/provider computer 102 can generate a refill response 410 to the transaction 404, 408. The refill response can provide an indication as to whether the prescriber approves or denies the request for refill in the refill request transaction 404 or modified refill request transaction 408. The indication can be, for example, a code or designation placed in an agreed upon field of the transaction 404, 408 to create the refill response 410. In step 540, the prescriber/provider computer 102 can transmit the refill response 410 to the service provider computer 106, via, for example, the network 110.

In step 542, the service provider computer 106 can receive the refill response 410 and can transmit the refill response 410 to the pharmacy computer that was the origination of the refill request transaction 404 and/or the modified refill request transaction 408. In certain example embodiments, the service provider computer 106 can conduct one or more post-edits or evaluations on the refill response 410 and can store all or a portion of the data in the refill response 410 in, for example, the database 182. In step 544, the pharmacy computer 104 can receive the refill response 410 from the service provider computer 106 via the network 110. In step 546, the pharmacy, such as a pharmacist or other pharmacy employee can dispense the medication or product or can provide the service to the patient based on information in the refill response 410, the first refill request transaction 204, and/or the modified refill request transaction 208. The process then continues to the END step.

The methods described and shown in FIGS. 3 and 5 may be carried out or performed in any suitable order as desired in various embodiments. Additionally, in certain exemplary embodiments, at least a portion of the operations may be carried out in parallel. Furthermore, in certain exemplary embodiments, less than or more than the operations described in FIGS. 3 and 5 may be performed.

Likewise, while FIGS. 3 and 5 have been described primarily in conjunction with FIGS. 2A and 4 respectively, it will be appreciated that variations of FIGS. 2A and 4 are available. As shown by FIG. 2B, the service provider computer 106 may include two or more distinct service provider computers 106a and 106b that are in communication with each other. These distinct service provider computers 106a and 106b may be owned, operated, and or located by the same or distinct and wholly-unrelated companies. The service provider computer 106a may be operative with the prescriber/provider computer 102 and the pharmacy computer 104, while the service provider computer 106b may be operative with other healthcare provider computers and/or other third-party entity computers. However, the service provider computer 106b may have a data processing arrangement with the service provider computer 106a. Under the data processing arrangement, the service provider computer 106a may be permitted to utilize or offer services of the service provider computer 106b, including the operations and use of the e-prescription evaluation module 180 and/or the database 182 to conduct e-prescription editing, evaluations, and rejections for e-prescription transactions, as discussed above in FIGS. 3 and 5. Accordingly, the services accessible by the service provider computer 106b, including the e-prescription transaction field evaluation and response messaging, may be available to the prescriber/provider computer 102 and the pharmacy computer 104 via the service provider computers 106a and 106b.

Accordingly, example embodiments disclosed herein can provide the technical effects of creating a system and methods that provide a real-time or near real time way to evaluate e-prescription transactions to determine any errors, issues, or additional information or services that can be associated therewith and for the generation of response/rejection messages to the e-prescription transaction that can be sent back to the originating prescriber at an originating prescriber/provider computer or an originating pharmacist at a pharmacy computer without sending the e-prescription transaction onward to its ultimate destination. In this regard, pharmacies and prescribers of medications, products, or services are less likely to have errors in e-prescription transactions that reach a pharmacy and pharmacists and/or pharmacy employees are less likely to have to track down medication, product, or service prescribers to correct errors or obtain additional information related to prescriptions from prescribers.

While certain example embodiments disclosed herein describe the e-prescription evaluation module 180 as being separate of the service provider computer 106, in alternate embodiments, the e-prescription evaluation module 180 or the functions that it completes may be part of the service provider computer 106. In those embodiments where the e-prescription evaluation module 180 is incorporated into the service provider computer 106, and with regard to the methods described above, the steps describing transmitting or receiving between the service provider computer 106 and the e-prescription evaluation module 180 may be internal transmissions within the service provider computer 106 or may be omitted altogether. Further, while the exemplary embodiments described herein disclose certain steps occurring at the service provider computer 106 and/or the e-prescription evaluation module 180, in alternative embodiments those steps described with reference to FIGS. 1-5 may alternately be completed at a pharmacy computer 104, a prescriber/provider computer 102, an e-prescription evaluation module 180, any combination thereof, and/or a combination of those devices along with the service provider computer 106. In those alternate embodiments, certain transmission/receiving steps described above with reference to FIGS. 1-5 may be omitted while others may be added, as understood by one or ordinary skill in the art. The intent being that in alternate embodiments, any of the devices/computers discussed in FIG. 1 are capable of completing any or any part of the methods described with reference to FIGS. 2A-5.

Various block and/or flow diagrams of systems and methods and/or computer program products according to example embodiments are described above. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosure may provide for a computer program product, that includes a computer usable medium (e.g., transitory or non-transitory) having a computer-readable program code or program instructions embodied therein, said computer-readable program code adapted to be executed to implement one or more functions specified in the flow diagram step or steps. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram step or steps.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

Many modifications and other embodiments of those set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A computer-implemented method, comprising:
receiving, by one or more service provider computers associated with a service provider and comprising one or more processors from a prescriber computer associated with a prescriber of medication, an e-prescription transaction comprising healthcare transaction data, wherein the healthcare transaction data comprises a medication identifier identifying a medication to be prescribed and at least one patient identifier identifying a patient to receive the prescribed medication;
identifying, by the one or more service provider computers, the healthcare transaction data in the e-prescription transaction;
determining, by the one or more service provider computers and based at least in part on the evaluation of the identified healthcare transaction data, if the e-prescription transaction includes a basis for rejection in the identified healthcare transaction data;
generating, by the one or more service provider computers and based at least in part on a positive determination that the e-prescription transaction includes the basis for rejection, a rejection response to the e-prescription transaction; and
transmitting, by the one or more service provider computers, the rejection response to the e-prescription transaction to the prescriber computer.

2. The computer-implemented method of claim 1, wherein the basis for rejection comprises an error in the identified healthcare transaction data.

3. The computer-implemented method of claim 1, wherein the rejection response comprises a rejection code identifying a basis for rejecting the e-prescription transaction.

4. The computer-implemented method of claim 3, wherein the rejection response further comprises an override code and wherein the method further comprises:
receiving, by the one or more service provider computers from the prescriber computer, a modified e-prescription transaction comprising a second set of healthcare transaction data, wherein the second set of healthcare transaction data comprises the medication identifier, at least one patient identifier identifying the patient, and the override code;
identifying, by the one or more service provider computers, the override code in the second set of healthcare transaction data in the modified e-prescription transaction;
determining, by the one or more service provider computers, that the override code is a valid override code; and
transmitting, by the one or more service provider computers and based at least in part on the determination that the override code is the valid override code, the modified e-prescription transaction to a pharmacy computer for a pharmacy.

5. The computer-implemented method of claim 1, wherein the positive determination that the e-prescription transaction includes the basis for rejection in the identified healthcare transaction data comprises:
identifying, by the one or more service provider computers, the medication identifier in the healthcare transaction data; and
determining, by the one or more service provider computers and based at least in part on the identified medication identifier, that at least one of an additional test needed for the patient or additional information in the e-prescription transaction is needed.

6. The computer-implemented method of claim 1, wherein determining if the e-prescription transaction includes the basis for rejection comprises determining, by the one or more service provider computers and based at least in part on the evaluation of the identified healthcare transaction data, if the e-prescription transaction is missing at least one required data element.

7. A system comprising:
at least one memory operable to store computer-executable instructions; and
at least one processor configured to access the at least one memory and execute the computer-executable instructions to:
receive, from a prescriber computer associated with a prescriber of medication, an e-prescription transaction comprising healthcare transaction data, wherein the healthcare transaction data comprises a medication identifier identifying a medication to be prescribed and at least one patient identifier identifying a patient to receive the prescribed medication;
identify the healthcare transaction data in the e-prescription transaction;
determine, based at least in part on the evaluation of the identified healthcare transaction data, if the e-prescription transaction includes a basis for rejection in the identified healthcare transaction data;
generate, based at least in part on a positive determination that the e-prescription transaction includes the basis for rejection, a rejection response to the e-prescription transaction; and
direct communication of the rejection response to the e-prescription transaction to the prescriber computer.

8. The system of claim 7, wherein the basis for rejection comprises an error in the identified healthcare transaction data.

9. The system of claim 7, wherein the rejection response comprises: a rejection code identifying a basis for rejecting the e-prescription transaction.

10. The system of claim 9, wherein the rejection response further comprises an override code and wherein the processor is further configured to access the at least one memory and execute the computer-executable instructions to:
receive a modified e-prescription transaction comprising a second set of healthcare transaction data, wherein the second set of healthcare transaction data comprises the medication identifier, at least one patient identifier identifying the patient, and the override code;
identify the override code in the second set of healthcare transaction data in the modified e-prescription transaction;
determine that the override code is a valid override code; and
direct, based at least in part on the determination that the override code is the valid override code, communication of the modified e-prescription transaction to a pharmacy computer for a pharmacy.

11. The system of claim 7, wherein the processor is further configured to positively determine that the e-prescription transaction includes the basis for rejection in the identified healthcare transaction data by accessing the at least one memory and executing the computer-executable instructions to:
identify the medication identifier in the healthcare transaction data;
determine, based on the identified medication identifier, that at least one of an additional test is needed for the patient based on the medication identified by the medication identifier or additional information in the e-prescription transaction is needed.

12. The system of claim 7, wherein the processor is configured to access the at least one memory and execute the computer-executable instructions to determine if the e-prescription transaction includes the basis for rejection comprises by determining, based at least in part on the evaluation of the identified healthcare transaction data, if the e-prescription transaction is missing at least one required data element.

13. A computer-implemented method, comprising:
receiving, by one or more service provider computers associated with a service provider and comprising one or more processors from a pharmacy computer for a pharmacy, an e-prescription refill request transaction comprising healthcare transaction data, wherein the healthcare transaction data comprises a medication identifier identifying a medication to be refilled and at least one patient identifier identifying a patient to receive the refilled medication;
identifying, by the one or more service provider computers, the healthcare transaction data in the e-prescription refill request transaction;
determining, by the one or more service provider computers and based at least in part on the evaluation of the identified healthcare transaction data, if the e-prescription refill request transaction includes a basis for rejection in the identified healthcare transaction data;
generating, by the one or more service provider computers and based at least in part on a positive determination that the e-prescription refill request transaction includes the basis for rejection, a rejection response to the e-prescription refill request transaction; and
transmitting, by the one or more service provider computers, the rejection response to the e-prescription refill request transaction to the pharmacy computer.

14. The computer-implemented method of claim 13, wherein the basis for rejection comprises an error in the identified healthcare transaction data.

15. The computer-implemented method of claim 13, wherein the rejection response comprises: a rejection code identifying a basis for rejecting the e-prescription refill request transaction and an override code and wherein the method further comprises:
receiving, by the one or more service provider computers from the pharmacy computer, a modified e-prescription refill request transaction comprising a second set of healthcare transaction data, wherein the second set of healthcare transaction data comprises the medication identifier, at least one patient identifier identifying the patient, and the override code;
identifying, by the one or more service provider computers, the override code in the second set of healthcare transaction data in the modified e-prescription refill request transaction;
determining, by the one or more service provider computers, that the override code is a valid override code; and
transmitting, by the one or more service provider computers and based at least in part on the determination that the override code is the valid override code, the modified e-prescription refill request transaction to a prescriber computer associated with a prescriber of medication.

16. The computer-implemented method of claim 13, wherein the positive determination that the e-prescription refill request transaction includes the basis for rejection in the identified healthcare transaction data comprises:
identifying, by the one or more service provider computers, the medication identifier in the healthcare transaction data; and
determining, by the one or more service provider computers and based at least in part on the identified medication identifier, that at least one of an additional test is needed for the patient based on the medication identified by the medication identifier or additional information in the e-prescription transaction is needed.

17. A system comprising:
at least one memory operable to store computer-executable instructions; and
at least one processor configured to access the at least one memory and execute the computer-executable instructions to:
receive, from a pharmacy computer for a pharmacy, an e-prescription refill request transaction comprising healthcare transaction data, wherein the healthcare transaction data comprises a medication identifier identifying a medication to be refilled and at least one patient identifier identifying a patient to receive the refilled medication;
identify the healthcare transaction data in the e-prescription refill request transaction;
determine, based at least in part on the evaluation of the identified healthcare transaction data, if the e-prescription refill request transaction includes a basis for rejection in the identified healthcare transaction data;
generate, based at least in part on a positive determination that the e-prescription refill request transaction includes the basis for rejection, a rejection response to the e-prescription refill request transaction; and
direct communication of the rejection response to the e-prescription refill request transaction to the pharmacy computer.

18. The system of claim 17, wherein the basis for rejection comprises an error in the identified healthcare transaction data.

19. The system of claim 17, wherein the rejection response comprises: a rejection code identifying a basis for rejecting the e-prescription refill request transaction and an override code and wherein the processor is configured to access the at least one memory and execute the computer-executable instructions to
receive, from the pharmacy computer, a modified e-prescription refill request transaction comprising a second set of healthcare transaction data, wherein the second set of healthcare transaction data comprises the medication identifier, at least one patient identifier identifying the patient, and the override code;
identify the override code in the second set of healthcare transaction data in the modified e-prescription refill request transaction;
determine that the override code is a valid override code; and
direct, based at least in part on the determination that the override code is the valid override code, communication of the modified e-prescription refill request transaction to a prescriber computer associated with a prescriber of medication.

20. The system of claim 17, wherein the processor is further configured to positively determine that the e-prescription transaction includes the basis for rejection in the identified healthcare transaction data by accessing the at least one memory and executing the computer-executable instructions to:
identifying, by the one or more service provider computers, the medication identifier in the healthcare transaction data; and
determining, by the one or more service provider computers and based at least in part on the identified medication identifier, that at least one of an additional test is needed for the patient based on the medication identified by the medication identifier or additional information in the e-prescription transaction is needed.
